(19) United States
(12) Patent Application Publication
(10) Pub. No.: US 2023/0007761 A1
(43) Pub. Date: Jan. 5, 2023

(54) DRIVE DEVICE AND VEHICLE

(71) Applicant: NIDEC CORPORATION, Kyoto (JP)

(72) Inventor: Takashi SHIRAISHI, Kyoto (JP)

(21) Appl. No.: 17/852,367

(22) Filed: Jun. 29, 2022

(30) Foreign Application Priority Data
Jun. 30, 2021 (JP) 2021-108483

(51) Int. Cl. H05F 3/02; B60R 16/06

(52) U.S. Cl. CPC H05F 3/02; B60R 16/06

(57) ABSTRACT

A drive device includes a neutralizing device electrically connecting a shaft and a housing. The shaft extending in the axial direction along a rotation axis has a shaft wall. The shaft wall is arranged inside a shaft tubular portion that has a tubular shape surrounding the rotation axis and expands in the radial direction. The housing has a columnar portion extending to one axial side. Portions of the neutralizing device and the columnar portion on the one axial side are arranged on the other axial side of the shaft wall in the shaft tubular portion. The neutralizing device contacts the columnar portion and at least one of an inner peripheral surface of the shaft tubular portion and the other axial end surface of the shaft wall.

### CROSS-REFERENCE TO RELATED APPLICATIONS

The present invention claims priority under 35 U.S.C. § 119 to Japanese Patent Application No. 2021-108483 filed on Jun. 30, 2021, the entire content of which is incorporated herein by reference.

### FIELD OF THE INVENTION

The present invention relates to a drive device and a vehicle.

### BACKGROUND

Conventionally, a neutralizing device that eliminates static electricity from a shaft of a motor portion of a drive device has been known. For example, a charge dissipating assembly, which serves as a neutralizing device, contacts a radially outer surface of a shaft to ground a shaft voltage.

However, when the neutralizing device is arranged radially outward of the shaft, there is a possibility that a radial size of the drive device increases.

### SUMMARY

An exemplary drive device of the present invention includes a shaft, a rotor, a stator, a housing, and a neutralizing device. The shaft extends in an axial direction along a rotation axis. The rotor is fixed to the shaft and is rotatable about the rotation axis. The stator radially faces the rotor with a gap interposed therebetween. The housing accommodates the rotor and the stator. The neutralizing device electrically connects the shaft and the housing. The shaft includes a shaft tubular portion having a tubular shape and a shaft wall. The shaft tubular portion surrounds the rotation axis. The shaft wall is arranged inside the shaft tubular portion and expands in the radial direction. A radially outer end portion of the shaft wall is connected to an inner surface of the shaft tubular portion. The housing has a columnar portion extending to one axial side. Portions of the neutralizing device and the columnar portion on the one axial side are arranged on the other axial side of the shaft wall in the shaft tubular portion. The neutralizing device contacts the columnar portion and at least one of an inner peripheral surface of the shaft tubular portion and the other axial end surface of the shaft wall.

An exemplary vehicle of the present invention includes the drive device described above.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a conceptual diagram illustrating a configuration example of a drive device;

FIG. 2 is a conceptual diagram illustrating a shaft neutralizing structure of the drive device according to the preferred embodiment;

FIG. 3 is a schematic diagram illustrating an example of a vehicle having the drive device mounted thereon;

FIG. 4A is a perspective view illustrating an example of a neutralizing device according to the preferred embodiment;

FIG. 4B is a perspective view illustrating a modification of the neutralizing device;

FIG. 5 is a conceptual diagram illustrating a shaft neutralizing structure of a drive device according to a first modification; and

FIG. 6 is a conceptual diagram illustrating a shaft neutralizing structure of a drive device according to a second modification.

### DETAILED DESCRIPTION

Hereinafter, an exemplary preferred embodiment will be described with reference to the drawings.

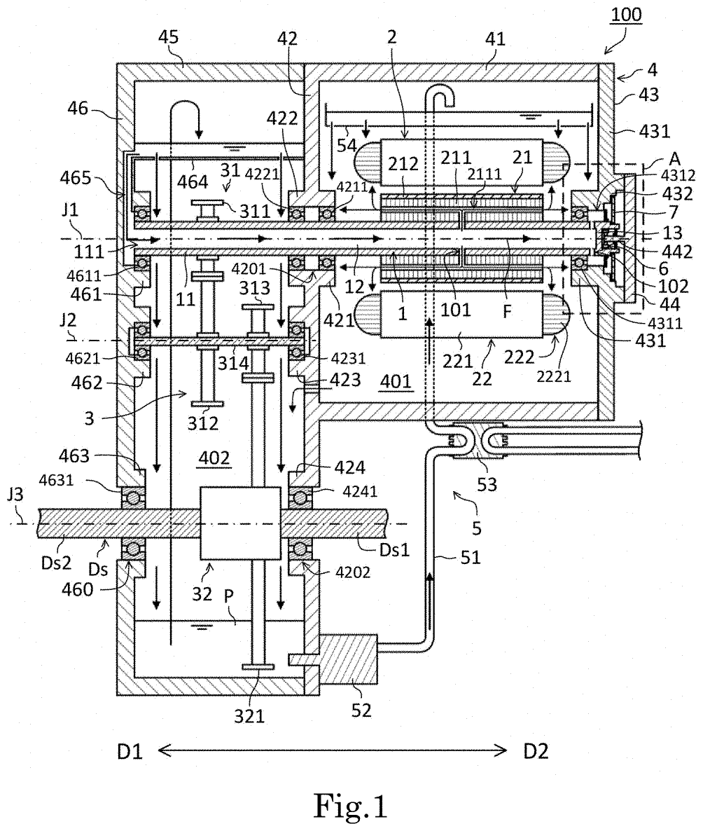

In the present specification, a direction parallel to a rotation axis J1 of a motor portion 2 is referred to as an “axial direction” of a drive device 100. In the axial direction, as illustrated in FIG. 1, the gear portion 3 side is defined as one axial side D1, and the motor portion 2 side is defined as the other axial side D2. In addition, a radial direction orthogonal to a predetermined axis, such as the rotation axis J1, is simply referred to as a “radial direction”, and a circumferential direction around the predetermined axis, such as the rotation axis J1, is simply referred to as a “circumferential direction”.

In the present specification, in the positional relationship between any one of orientations, lines, and surfaces and another one, the term “parallel” means not only a state where both never cross each other no matter how long they extend, but also a state where both are substantially parallel. In addition, the term “perpendicular” includes not only a state where both intersect each other at 90 degrees, but also a state where both are substantially perpendicular. That is, the terms “parallel” and “perpendicular” each include a state where the positional relationship between both permits an angular deviation to a degree that does not depart from the gist of the present invention.

In the present specification, the term “extending” in a predetermined direction includes a configuration in which an extending direction is substantially the predetermined direction in addition to a configuration in which the extending direction is strictly the predetermined direction. That is, the term “extending” in the predetermined direction includes a configuration in which there is a directional deviation from the predetermined direction to an extent that does not depart from the gist of the present invention. The same applies to the term “expanding” in a predetermined direction.

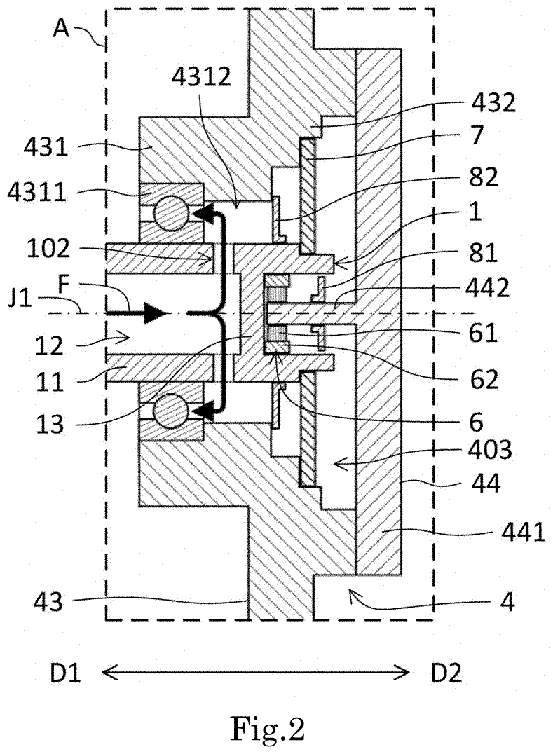

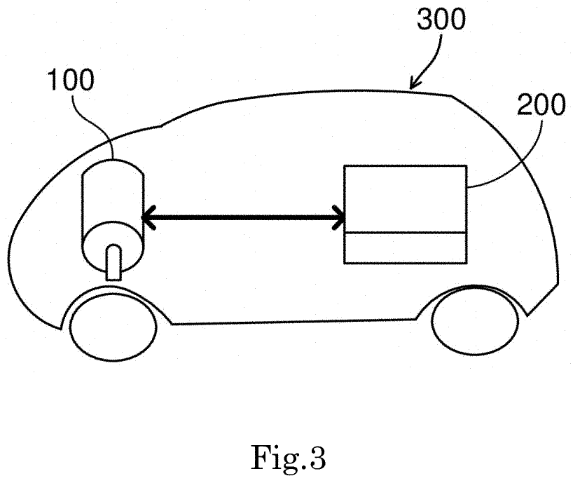

FIG. 1 is a conceptual diagram illustrating a configuration example of the drive device 100. FIG. 2 is a conceptual diagram illustrating a shaft neutralizing structure of the drive device 100 according to the preferred embodiment. FIG. 3 is a schematic diagram illustrating an example of a vehicle 300 having the drive device 100 mounted thereon. Note that FIGS. 1 and 2 are merely conceptual diagrams, and a layout and a dimension of each portion are not necessarily identical to those of the actual drive device 100 in a strict sense. In addition, FIG. 2 is an enlarged view of a portion A surrounded by a broken line in FIG. 1. In addition, FIG. 3 conceptually illustrates the vehicle 300.

In the present preferred embodiment, the drive device 100 is mounted on the vehicle 300 such as a hybrid vehicle (HV), a plug-in hybrid vehicle (PHV), or an electric vehicle (EV) in which at least the motor is used as a power source as illustrated in FIG. 3. The drive device 100 is used as the power source of the above-described vehicle 300. The vehicle 300 has the drive device 100. Since the drive device 100 is installed, the drive device 100 of the vehicle 300 including a neutralizing mechanism between a shaft 1 and a housing 4 can be downsized. In FIG. 3, the drive device 100 drives front wheels of the vehicle 300. Note that, the drive device 100 may drive at least any of the wheels. In addition, the vehicle 300 further includes a battery 200. The battery 200 stores electric power to be supplied to the drive device 100.

As illustrated in FIG. 1, the drive device 100 includes a shaft 1, a motor portion 2, a gear portion 3, a housing 4, a liquid circulation portion 5, a neutralizing device 6, a rotation detector 7, a first seal member 81, and a second seal member 82.

The shaft 1 axially extends along the rotation axis J1. As described above, the drive device 100 includes the shaft 1. The shaft 1 is rotatable about the rotation axis J1. As illustrated in FIG. 1, the shaft 1 is rotatably supported by the housing 4 via a first motor bearing 4211, a second motor bearing 4221, a third motor bearing 4311, and a fourth motor bearing 4611 to be described later. That is, the drive device 100 includes these bearings 4211, 4221, 4311, and 4611. These bearings 4211, 4221, 4311, and 4611 rotatably support the shaft 1.

The shaft 1 has a tubular shape extending in the axial direction. A fluid F flows inside the shaft 1. The drive device 100 further includes this fluid F. Note that the fluid F is a lubricant that lubricates the gear portion 3 and the bearings of the drive device 100, and is, for example, an automatic transmission fluid (ATF) in the present preferred embodiment. In addition, the fluid F is used as a refrigerant for cooling the motor portion 2 and the like. As the shaft 1 rotates, the fluid F flowing inside the shaft 1 can be supplied to the motor portion 2, the first motor bearing 4211, the third motor bearing 4311, and the like through a first shaft through-hole 101 to be described later. Therefore, a stator 22 (particularly, a coil end 2221 to be described later), the above-described bearings 4211 and 4311, and the like can be cooled by the fluid F.

Note that the shaft 1 may be dividable, for example, at an intermediate portion in the axial direction. When the shaft 1 is dividable, the divided shafts 1 are connected by spline fitting, for example. Alternatively, the divided shafts 1 may be connected by screw coupling using a male screw and a female screw, or may be joined by a fixing method such as press-fitting and welding. When the fixing method such as press-fitting or welding is adopted, serrations combining recesses and protrusions extending in the axial direction may be adopted. With such a configuration, it is possible to reliably transmit the rotation.

The shaft 1 includes a shaft tubular portion 11 having a tubular shape surrounding the rotation axis J1. The shaft tubular portion 11 has a tubular shape and extends in the axial direction along the rotation axis J1. The shaft tubular portion 11 has conductivity, and is made of metal in the present preferred embodiment. In addition, the shaft 1 includes a hollow portion 12 and an inlet 111. The hollow portion 12 is a space surrounded by an inner peripheral surface of the shaft tubular portion 11, and is arranged inside the shaft tubular portion 11. The inlet 111 is one axial end portion of the shaft tubular portion 11 having the tubular shape, and is connected to a flow passage 465 of a gear lid 46 to be described later. The fluid F flows from the flow passage 465 into the hollow portion 12 through the inlet 111.

Next, the shaft 1 further includes a shaft wall 13. The shaft wall 13 is arranged inside the shaft tubular portion 11 and expands in the radial direction. The shaft wall 13 is arranged on the other axial side D2 of the shaft tubular portion 11. In the present preferred embodiment, one axial end portion of the shaft wall 13 is arranged on the one axial side D1 with respect to the rotation detector 7 and the second seal member 82. A radially outer end portion of the shaft wall 13 is connected to an inner surface of the shaft tubular portion 11. Preferably, the shaft wall 13 is integrated with the shaft tubular portion 11. For example, the shaft wall 13 and the shaft tubular portion 11 are mutually different parts of the same member in the present preferred embodiment. Since the shaft wall 13 is integrated with the shaft tubular portion 11, the shaft 1 can be easily manufactured. In addition, the number of components of the shaft 1 can be reduced, and thus, the drive device 100 is easily assembled. However, the present invention is not limited to this example, and the shaft wall 13 may be a separate member from the shaft tubular portion 11.

The first shaft through-hole 101 is arranged in the shaft tubular portion 11. That is, the shaft 1 further includes the first shaft through-hole 101 penetrating the shaft tubular portion 11 in the radial direction. The number of first shaft through-holes 101 may be one or plural. When the shaft 1 rotates, the fluid F in the shaft tubular portion 11 flows out from the hollow portion 12 to the outside of the shaft tubular portion 11 through the first shaft through-hole 101 by centrifugal force. In the present preferred embodiment, as illustrated in FIG. 1, the first shaft through-hole 101 is arranged on the other axial side D2 with respect to one axial end portion of the rotor 21 and on the one axial side D1 with respect to the other axial end portion of the rotor 21, and is connected to a rotor through-hole 2111 to be described later. However, the present invention is not limited to the example of FIG. 1, and the first shaft through-hole 101 may be arranged on the one axial side D1 with respect to the one axial end portion of the rotor 21 and on the other axial side D2 with respect to the first motor bearing 4211, and may be arranged on the other axial side D2 with respect to the other axial end portion of the rotor 21 and on the one axial side D1 with respect to the third motor bearing 4311. That is, at least a part of the first shaft through-hole 101 may be arranged in at least one of these positions. Note that the above-described example does not exclude a configuration in which the first shaft through-hole 101 and the rotor through-hole 2111 are omitted.

A second shaft through-hole 102 is arranged in the shaft tubular portion 11. The shaft 1 further includes the second shaft through-hole 102. The second shaft through-hole 102 penetrates the shaft tubular portion 11 in the radial direction. Alternatively, the second shaft through-hole 102 may penetrate the shaft tubular portion 11 in a direction intersecting the radial direction and the axial direction. Note that the second shaft through-hole 102 is an example of a “shaft through-hole” of the present invention.

The number of second shaft through-holes 102 may be one or plural. In the latter case, the second shaft through-holes 102 can be arranged at equal intervals or different intervals in the circumferential direction. Note that the above-described example does not exclude a configuration in which the second shaft through-hole 102 is omitted.

In the present preferred embodiment, the second shaft through-hole 102 is arranged at the other axial side D2 with respect to the first shaft through-hole 101 (see FIG. 1). A radially outer end portion of the second shaft through-hole 102 is connected to a third motor bearing holder 431. A radially inner end portion of the second shaft through-hole 102 is arranged on the one axial side D1 with respect to the shaft wall 13 and is connected to the hollow portion 12. Then, the fluid F flowing in the shaft tubular portion 11 can be supplied to the third motor bearing 4311 through the second shaft through-hole 102.

In the present preferred embodiment, the one axial end portion of the shaft wall 13 is arranged on the one axial side D1 with respect to the other axial end portion of the opening 4312. Alternatively, the one axial end portion of the shaft wall 13 may be at the same axial position as the other axial end portion of the opening 4312. Then, an interval between the radially inner end portion of the second shaft through-hole 102 and the shaft wall 13 in the axial direction can be further narrowed. Therefore, for example, the fluid F flowing inside the shaft tubular portion 11 toward the other axial side D2 easily flows to the second shaft through-hole 102, and the fluid F staying between the radially inner end portion of the second shaft through-hole 102 and the shaft wall 13 further decreases. Thus, the fluid F in the shaft tubular portion 11 can be more smoothly supplied to the third motor bearing 4311. However, the above-described example does not exclude a configuration in which the one axial end portion of the shaft wall 13 is arranged on the other axial side D2 with respect to the other axial end portion of the opening 4312.

The radially outer end portion of the second shaft through-hole 102 is arranged on the other axial side D2 with respect to the third motor bearing 4311. Preferably, the radially outer end portion of the second shaft through-hole 102 is arranged on the one axial side D1 with respect to the other axial end portion of the opening 4312, which will be described later, of a housing lid 43. More preferably, the radially outer end portion of the second shaft through-hole 102 is arranged on the one axial side D1 with respect to the second seal member 82. As described above, the radially outer end portion of the second shaft through-hole 102 is connected to the inside of the third motor bearing holder 431. For this reason, the fluid F hardly enters a space 403 to be described later in which the other axial end portion of the shaft tubular portion 11 is arranged as compared with a configuration in which the radially outer end portion of the second shaft through-hole 102 is arranged on the other axial side D2 with respect to the other axial end portion of the opening 4312 (that is, configuration in which the radially outer end portion of the second shaft through-hole 102 is connected to the outside of the third motor bearing holder 431). Therefore, it is possible to suppress the fluid F from being applied to the neutralizing device 6 in the shaft tubular portion 11. Note that the above-described example does not exclude a configuration in which the radially outer end portion of the second shaft through-hole 102 is arranged on the other axial side D2 with respect to the other axial end portion of the opening 4312 or arranged on the other axial side D2 with respect to the second seal member 82.

The motor portion 2 is a DC brushless motor. The motor portion 2 is a drive source of the drive device 100, and is driven by power from an inverter (not illustrated). That is, the motor portion 2 is an inner rotor type motor in which the rotor 21 is rotatably arranged inward of the stator 22. As illustrated in FIG. 1, the motor portion 2 includes the rotor 21 and the stator 22.

The rotor 21 is supported by the shaft 1. The drive device 100 includes the rotor 21. The rotor 21 is fixed to the shaft 1 and is rotatable about the rotation axis J1. The rotor 21 rotates when electric power is supplied from a power source unit (not illustrated) of the drive device 100 to the stator 22. The rotor 21 includes a rotor core 211 and a magnet 212. The rotor core 211 is formed by, for example, laminating thin electromagnetic steel plates. The rotor core 211 is a cylindrical body extending along the axial direction, and is fixed to a radially outer surface of the shaft 1. A plurality of the magnets 212 are fixed to the rotor core 211. The plurality of magnets 212 are arranged along the circumferential direction with magnetic poles arranged alternately.

In addition, the rotor core 211 has the rotor through-hole 2111. The rotor through-hole 2111 penetrates the rotor core 211 in the axial direction and is connected to the first shaft through-hole 101. The rotor through-hole 2111 is used as a flow path of the fluid F that also functions as the refrigerant. When the rotor 21 rotates, the fluid F flowing through the hollow portion 12 of the shaft 1 can flow into the rotor through-hole 2111 via the first shaft through-hole 101. In addition, the fluid F flowing into the rotor through-hole 2111 can flow out from both axial end portions of the rotor through-hole 2111 to the outside. The fluid F having flowed out flies toward the stator 22 and cools, for example, a coil portion 222 (particularly, the coil end 2221 thereof) and the like. In addition, the fluid F having flowed out flies toward the first motor bearing 4211, the third motor bearing 4311, and the like that rotatably support the shaft 1, and lubricates and cools these bearings 4211 and 4311.

The stator 22 faces the rotor 21 with a gap therebetween in the radial direction. The drive device 100 includes the stator 22. The stator 22 is arranged radially outward of the rotor 21. The stator 22 includes a stator core 221 and the coil portion 222. The stator 22 is held by a first housing tubular portion 41 to be described later. The stator core 221 has a plurality of magnetic pole teeth (not illustrated) extending radially inward from an inner peripheral surface of an annular yoke. The coil portion 222 is formed by winding a conductive wire around the magnetic pole teeth via an insulator (not illustrated). The coil portion 222 has the coil end 2221 protruding from an axial end surface of the stator core 221.

Next, the gear portion 3 is a power transmission device that transmits power of the motor portion 2 to a drive shaft Ds to be described later. The gear portion 3 includes a deceleration device 31 and a differential device 32.

The deceleration device 31 is connected to the shaft 1. The deceleration device 31 has a function of reducing a rotation speed of the motor portion 2 and increasing torque output from the motor portion 2 according a reduction ratio. The deceleration device 31 transmits the torque output from the motor portion 2 to the differential device 32. That is, the gear portion 3 is connected to the other axial side D2 of the shaft 1 that rotates about the rotation axis J1 extending along the horizontal direction.

The deceleration device 31 includes a main drive gear 311, an intermediate driven gear 312, a final drive gear 313, and an intermediate shaft 314. The torque output from the motor portion 2 is transmitted to a ring gear 321 of the differential device 32 via the shaft 1, the main drive gear 311, the intermediate driven gear 312, the intermediate shaft 314, and the final drive gear 313.

The main drive gear 311 is arranged on an outer peripheral surface of the shaft 1. The main drive gear 311 may be the same member as the shaft 1, or may be a separate member and be firmly fixed. The main drive gear 311 rotates about the rotation axis J1 together with the shaft 1.

The intermediate shaft 314 extends along the intermediate axis J2 parallel to the rotation axis J1. Both ends of the intermediate shaft 314 are supported by a first intermediate bearing 4231 and a second intermediate bearing 4621 to be rotatable about an intermediate axis J2. The intermediate driven gear 312 and the final drive gear 313 are arranged on an outer peripheral surface of the intermediate shaft 314. The intermediate driven gear 312 may be the same member as the intermediate shaft 314, or may be a separate member and be firmly fixed thereto.

The intermediate driven gear 312 and the final drive gear 313 rotate integrally with the intermediate shaft 314 about the intermediate axis J2. The intermediate driven gear 312 meshes with the main drive gear 311. The final drive gear 313 meshes with the ring gear 321 of the differential device 32.

The torque of the shaft 1 is transmitted from the main drive gear 311 to the intermediate driven gear 312. Then, the torque transmitted to the intermediate driven gear 312 is transmitted to the final drive gear 313 through the intermediate shaft 314. Further, the torque is transmitted from the final drive gear 313 to the ring gear 321.

The differential device 32 is attached to the drive shaft Ds. The differential device 32 has the ring gear 321. The ring gear 321 transmits the torque transmitted from the deceleration device 31 to the drive shaft Ds. The drive shaft Ds is attached to each of the one axial side D1 and the other axial side D2 of the differential device 32. A drive shaft Ds2 on the one axial side D1 is rotatably supported by a second output bearing 4631 to be described later. A drive shaft Ds1 on the other axial side D2 is rotatably supported by a first output bearing 4241 to be described later. For example, the differential device 32 transmits the torque to the drive shafts Ds1 and Ds2 on both the axial sides while absorbing a rotation speed difference between the drive shafts Ds1 and Ds2 on both the axial sides when the vehicle turns.

A lower end portion of the ring gear 321 is arranged inside a liquid storage portion P to be described later in which the fluid F stored in a lower portion of a gear portion accommodation space 402 is stored (see FIG. 1). For this reason, the fluid F is scraped up by gear teeth of the ring gear 321 when the ring gear 321 rotates. The gears and bearings of the gear portion 3 are lubricated or cooled by the fluid F scraped up by the ring gear 321. A part of the scraped fluid F is stored in a tray portion 464 to be described later, and is also used for cooling the motor portion 2 via the shaft 1.

The housing 4 accommodates the shaft 1, the motor portion 2, and the gear portion 3. The housing 4 includes the first housing tubular portion 41, a side plate 42, the housing lid 43, a cover member 44, a second housing tubular portion 45, and the gear lid 46. Note that the first housing tubular portion 41, the side plate 42, the housing lid 43, the cover member 44, the second housing tubular portion 45, and the gear lid 46 are formed using, for example, a conductive material, and in the present preferred embodiment, are formed using a metal material such as iron, aluminum, or an alloy thereof. In addition, these are preferably formed using the same material in order to suppress contact corrosion of dissimilar metals at the contact portion. However, the present invention is not limited to this example, and these may be formed using materials other than the metal materials, or at least a part of these may be formed using different materials.

In addition, the housing 4 accommodates the rotor 21 and the stator 22. As described above, the drive device 100 includes the housing 4. Specifically, the housing 4 has a motor accommodation space 401. The motor accommodation space 401 is a space surrounded by the first housing tubular portion 41, the side plate 42, and the housing lid 43, and accommodates the rotor 21, the stator 22, the first motor bearing 4211, the third motor bearing 4311, and the like.

In addition, the housing 4 accommodates the gear portion 3 as described above. Specifically, the housing 4 includes the gear portion accommodation space 402. The gear portion accommodation space 402 is a space surrounded by the side plate 42, the second housing tubular portion 45, and the gear lid 46, and accommodates the deceleration device 31, the differential device 32, and the like.

The liquid storage portion P in which the fluid F is stored is arranged in the lower portion in the gear portion accommodation space 402. A portion of the differential device 32 is immersed in the liquid storage portion P. The fluid F stored in the liquid storage portion P is scraped up by the operation of the differential device 32 and supplied to the inside of the gear portion accommodation space 402. That is, the fluid F is scraped up by a tooth surface of the ring gear 321 when the ring gear 321 of the differential device 32 rotates. A part of the scraped fluid F is supplied to the gears and the bearings of the deceleration device 31 and the differential device 32 in the gear portion accommodation space 402 and used for lubrication. In addition, the other part of the scraped fluid F is supplied to the inside of the shaft 1, and is supplied to the rotor 21 and the stator 22 of the motor portion 2 and the bearings in the gear portion accommodation space 402 to be used for cooling and lubrication.

The first housing tubular portion 41 has a tubular shape extending in the axial direction. The motor portion 2, a fluid reservoir 54 to be described later, and the like are arranged inside the first housing tubular portion 41. In addition, the stator core 221 is fixed to an inner surface of the first housing tubular portion 41.

The side plate 42 covers one axial end portion of the first housing tubular portion 41 and covers the other axial end portion of the second housing tubular portion 45. The side plate 42 expands in a direction intersecting the rotation axis J1 and divides the first housing tubular portion 41 from the second housing tubular portion 45. In the present preferred embodiment, the first housing tubular portion 41 and the side plate 42 are different parts of the single member. Since these are integrally formed, the rigidity thereof can be enhanced. However, the present invention is not limited to this example, and both may be separate members.

The side plate 42 has a side plate through-hole 4201 through which the shaft 1 is inserted and a first drive shaft through-hole 4202. The side plate through-hole 4201 and the first drive shaft through-hole 4202 penetrates the side plate 42 in the axial direction. The center of the side plate through-hole 4201 coincides with the rotation axis J1. The shaft 1 is inserted through the side plate through-hole 4201. The center of the first drive shaft through-hole 4202 coincides with a drive axis J3. The drive shaft Ds1 on the other axial side D2 is inserted through the first drive shaft through-hole 4202. An oil seal (not illustrated) for sealing between the drive shaft Ds1 and the first drive shaft through-hole 4202 is arranged in a gap therebetween.

In addition, the side plate 42 further includes a first motor bearing holder 421, a second motor bearing holder 422, a first intermediate bearing holder 423, and a first output bearing holder 424. The first motor bearing holder 421 is arranged on the other axial side D2 of the side plate through-hole 4201 on the side plate 42 and holds the first motor bearing 4211. The second motor bearing holder 422 is arranged along an outer edge of one axial end portion of the side plate through-hole 4201 and holds the second motor bearing 4221. The first intermediate bearing holder 423 is arranged on one axial end surface of the side plate 42 and holds the first intermediate bearing 4231. The first output bearing holder 424 is arranged along an outer edge of one axial end portion of the first drive shaft through-hole 4202 on the side plate 42, and holds the first output bearing 4241. The first motor bearing 4211, the second motor bearing 4221, the first intermediate bearing 4231, and the first output bearing 4241 are ball bearings in the present preferred embodiment.

The housing lid 43 expands in a direction intersecting the rotation axis J1 and covers the other axial end portion of the first housing tubular portion 41. The housing lid 43 is attached to the other axial end portion of the first housing tubular portion 41. The housing lid 43 can be fixed to the first housing tubular portion 41 by, for example, a screw, but is not limited thereto, and a method of firmly fixing the housing lid 43 to the first housing tubular portion 41, such as screwing or press-fitting, can be widely adopted. As a result, the housing lid 43 can be brought into close contact with the other axial end portion of the first housing tubular portion 41. Note that the term “close contact” means to have such a sealing property to an extent that the fluid F inside the members does not leak to the outside and to an extent that foreign matter such as external water, dirt, or dust does not enter. It is assumed that the same is applied below for the close contact.

In addition, the housing lid 43 includes the third motor bearing holder 431. The third motor bearing holder 431 is arranged on one axial end surface of the housing lid 43. The third motor bearing holder 431 holds the third motor bearing 4311. The drive device 100 includes the third motor bearing holder 431 and the third motor bearing 4311. The third motor bearing 4311 rotatably supports the shaft 1. The third motor bearing holder 431 is an example of a “bearing holder” of the present invention. The third motor bearing 4311 is an example of a “bearing” of the present invention, and is a ball bearing in the present preferred embodiment.

The third motor bearing holder 431 has the opening 4312 through which the shaft 1 is inserted. The opening 4312 penetrates the housing lid 43 in the axial direction and surrounds the rotation axis J1 when viewed from the axial direction.

In addition, the housing lid 43 further includes a detector holder 432 that holds the rotation detector 7. In the present preferred embodiment, the detector holder 432 is a step arranged on the other axial side D2 of the housing lid 43. This step has an annular shape surrounding the rotation axis J1.

The cover member 44 is attached to the other axial end surface of the housing lid 43. The cover member 44 can be attached to the housing lid 43 by, for example, screwing, but is not limited thereto, and a method of firmly fixing the cover member 44 to the housing lid 43, such as screwing or press-fitting, can be widely adopted. In the present preferred embodiment, the cover member 44 forms the space 403 together with the housing lid 43. The space 403 is a space surrounded by the housing lid 43 and the cover member 44, and accommodates the other axial end portion of the shaft 1, the rotation detector 7, the second seal member 82, and the like.

The cover member 44 includes a plate portion 441 and a columnar portion 442. The plate portion 441 has a plate shape expanding in a direction intersecting the rotation axis J1, and expands in the radial direction from the rotation axis J1 in the present preferred embodiment. The plate portion 441 is arranged on the other axial side D2 with respect to the other axial end portion of the shaft 1, and covers the opening 4312 and the other axial end portion of the shaft 1. The columnar portion 442 extends in the axial direction. The drive device 100 includes the columnar portion 442. Specifically, the columnar portion 442 extends from the plate portion 441 on the one axial side D1 along the rotation axis J1. The center of the columnar portion 442 coincides with the rotation axis J1 when viewed from the axial direction. The one axial side D1 of the columnar portion 442 is accommodated in the hollow portion 12 at the other axial end portion of the shaft tubular portion 11.

The second housing tubular portion 45 has a tubular shape surrounding the rotation axis J1 and extends in the axial direction. The other axial end portion of the second housing tubular portion 45 is connected to the side plate 42 and covered with the side plate 42. In the present preferred embodiment, the second housing tubular portion 45 is detachably attached to the one axial end portion of the side plate 42. In addition, the second housing tubular portion 45 can be attached to the side plate 42 by, for example, fixing with a screw, but is not limited thereto, and a method of firmly fixing the second housing tubular portion 45 to the side plate 42, such as screwing or press-fitting, can be widely adopted. As a result, the second housing tubular portion 45 can be brought into close contact with the one axial end portion of the side plate 42.

The gear lid 46 expands in a direction intersecting the rotation axis J1. The gear portion 3 is arranged inside the second housing tubular portion 45 and the gear lid 46. In the present preferred embodiment, the second housing tubular portion 45 and the gear lid 46 are different parts of the single member. However, the present invention is not limited to this example, and the second housing tubular portion 45 and the gear lid 46 may be separate members.

The gear lid 46 includes a second drive shaft through-hole 460. The center of the second drive shaft through-hole 460 coincides with the drive axis J3. The drive shaft Ds is inserted through the second drive shaft through-hole 460. An oil seal (not illustrated) for sealing between the drive shaft Ds on the one axial side D1 and the second drive shaft through-hole 460 is arranged in a gap therebetween.

The gear lid 46 further includes a fourth motor bearing holder 461, a second intermediate bearing holder 462, and a second output bearing holder 463. These bearing holders 461, 462, and 463 are arranged on the other axial end surface of the gear lid 46 in the gear portion accommodation space 402. The fourth motor bearing holder 461 and the second intermediate bearing holder 462 are arranged on the other axial end surface of the gear lid 46. The fourth motor bearing holder 461 holds the fourth motor bearing 4611. The second intermediate bearing holder 462 holds the second intermediate bearing 4621. The second output bearing holder 463 is arranged along an outer edge of the other axial end portion of the second drive shaft through-hole 460 in the gear lid 46, and holds the second output bearing 4631. The fourth motor bearing 4611, the second intermediate bearing 4621, and the second output bearing 4631 are ball bearings in the present preferred embodiment.

The gear lid 46 includes the tray portion 464 and the flow passage 465. The tray portion 464 is arranged in the other axial end surface of the gear lid 46 and has a recess recessed vertically downward. The tray portion 464 can store the fluid F scraped up by the ring gear 321. The flow passage 465 is a passage for the fluid F and connects the tray portion 464 and the inlet 111 of the shaft 1. The fluid F stored in the tray portion 464 is supplied to the flow passage 465 and flows into the hollow portion 12 from the inlet 111 at the one axial end portion of the shaft 1.

Next, the liquid circulation portion 5 will be described. The liquid circulation portion 5 includes a pipe 51, a pump 52, a cooler unit 53, and the fluid reservoir 54.

The pipe 51 connects the pump 52 and the fluid reservoir 54 arranged inside the first housing tubular portion 41, and supplies the fluid F to the fluid reservoir 54. The pump 52 sucks the fluid F stored in a lower region of the gear portion accommodation space 402. The pump 52 is an electric pump, but is not limited thereto. For example, the pump 52 may be configured to be driven by utilizing a part of the power of the shaft 1 of the drive device 100.

The cooler unit 53 is arranged between the pump 52 and the fluid reservoir 54 in the pipe 51. That is, the fluid F sucked by the pump 52 passes through the cooler unit 53 via the pipe 51 and then is sent to the fluid reservoir 54. For example, a refrigerant such as water supplied from the outside is supplied to the cooler unit 53. The cooler unit 53 exchanges heat between the refrigerant and the fluid F to lower the temperature of the fluid F.

The fluid reservoir 54 is a tray arranged vertically above the stator 22 inside the motor accommodation space 401. A dropping hole (whose reference sign is omitted) is formed at a bottom of the fluid reservoir 54, and the motor portion 2 is cooled by dropping the fluid F from the dropping hole. The dropping hole is formed above the coil end 2221 of the coil portion 222 of the stator 22, for example, and the coil portion 222 is cooled by the fluid F.

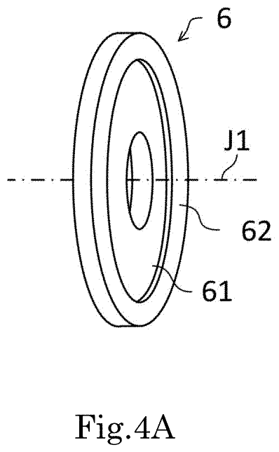

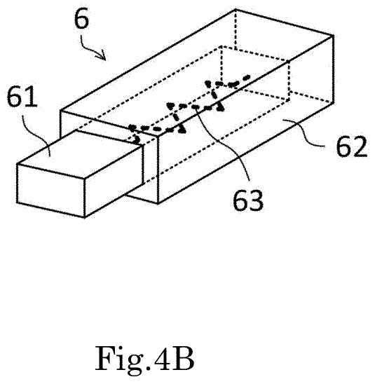

Next, the neutralizing device 6 will be described with reference to FIGS. 2, 4A, and 4B. FIG. 4A is a perspective view illustrating an example of the neutralizing device 6 according to the preferred embodiment. FIG. 4B is a perspective view illustrating a modification of the neutralizing device 6.

The neutralizing device 6 electrically connects the shaft 1 and the housing 4. As described above, the drive device 100 includes the neutralizing device 6. The neutralizing device 6 is accommodated in the hollow portion 12 at the other axial end portion of the shaft 1.

Specifically, portions the neutralizing device 6 and the columnar portion 442 on the one axial side D1 are arranged on the other axial side D2 with respect to the shaft wall 13 in the shaft tubular portion 11. The neutralizing device 6 is arranged between the shaft tubular portion 11 and the columnar portion 442.

The neutralizing device 6 contacts the shaft 1 and the columnar portion 442 and is electrically connected to the both. For example, as illustrated in FIG. 2, a radially inner end portion of the neutralizing device 6 contacts an outer peripheral surface of the columnar portion 442 in the present preferred embodiment. In addition, a radially outer end portion of the neutralizing device 6 contacts an inner peripheral surface of the shaft tubular portion 11, and one axial end portion of the neutralizing device 6 contacts the shaft wall 13. However, the present invention is not limited to the example of FIG. 2, and the neutralizing device 6 may be separated from one of the shaft tubular portion 11 and the shaft wall 13. For example, the radially outer end portion of the neutralizing device 6 may be separated radially inward from the inner peripheral surface of the shaft tubular portion 11. Alternatively, the one axial end portion of the neutralizing device 6 may be separated from the shaft wall 13 to the other axial side D2. That is, it is sufficient for the neutralizing device 6 to contact the columnar portion 442 and at least one of the inner peripheral surface of the shaft tubular portion 11 and the other axial end surface of the shaft wall 13.

Since the portions of the neutralizing device 6 and the columnar portion 442 on the one axial side D1 are arranged in the shaft tubular portion 11 according to the above-described arrangement of the neutralizing device 6, the shaft 1 can be electrically connected to the columnar portion 442 of the housing 4 by the neutralizing device 6 in the shaft tubular portion 11. In other words, the neutralizing mechanism between the shaft 1 and the housing 4 using the neutralizing device 6 is not necessarily arranged outside the shaft tubular portion 11. Therefore, the drive device 100 including the neutralizing mechanism between the shaft 1 and the housing 4 can be downsized.

Further, since the above-described neutralizing mechanism is arranged on the other axial side D2 of the shaft wall 13 inside the shaft tubular portion 11, the fluid F for lubricating and cooling the stator 22, the third motor bearing 4311, and the like is hardly applied to the neutralizing device 6. For example, the shaft wall 13 can prevent the fluid F flowing in the shaft tubular portion 11 from being directly applied to the neutralizing device 6 in the shaft tubular portion 11. In addition, it is also possible to suppress the fluid F outside the shaft 1 from being applied to the neutralizing device 6 in the shaft tubular portion 11 since the neutralizing device 6 is arranged in the shaft tubular portion 11. Therefore, the neutralizing device 6 can favorably maintain the electrical connection between the shaft 1 and the columnar portion 442 of the housing 4.

In addition, when the neutralizing device 6 contacts both the inner peripheral surface of the shaft tubular portion 11 and the other axial end surface of the shaft wall 13 as illustrated in FIG. 2, the contact area between the neutralizing device 6 and the shaft 1 can be further widened. Therefore, the electrical conductivity between the both can be further enhanced, and thus, an effect of eliminating static electricity of the shaft 1 by the neutralizing device 6 can be improved.

In the present preferred embodiment, the neutralizing device 6 includes a conductive member 61 and a holding member 62 having conductivity. The holding member 62 holds the conductive member.

The conductive member 61 may have, for example, a brush shape including a plurality of fibers extending in the radial direction, or may be a molded body. The conductive member 61 is formed using a material having conductivity. As the material of the conductive member 61, a material having good slidability is preferably used, and a material having a low friction coefficient is more preferably used. As the material of the conductive member 61, for example, a composite resin containing a conductive filler such as a carbon fiber or metal can be adopted. The holding member 62 is made of metal, for example, and accommodates a part of the conductive member 61 therein.

In the present preferred embodiment, a tip end (that is, a radially inner end portion) of the conductive member 61 contacts the outer peripheral surface of the columnar portion 442. The holding member 62 is fixed to the shaft 1. However, the present invention is not limited to the example of the present preferred embodiment, and the tip end (that is, a radially outer end portion) of the conductive member 61 may contact the shaft 1, and the holding member 62 may be fixed to the outer peripheral surface of the columnar portion 442. At this time, it is sufficient for the tip end of the conductive member 61 to contact at least one of the inner peripheral surface of the shaft tubular portion 11 and the other axial end surface of the shaft wall 13.

In the present preferred embodiment, the neutralizing device 6 has an annular shape surrounding the rotation axis J1, and is fitted to the inner peripheral surface of the shaft tubular portion 11. Then, since the annular neutralizing device 6 can be fitted into the inner peripheral surface of the shaft tubular portion 11, the neutralizing device 6 can be stably fixed inside the shaft tubular portion 11.

For example, as illustrated in FIG. 4A, the conductive member 61 and the holding member 62 have an annular shape centered on the rotation axis J1. The radially outer side of the conductive member 61 is held by a radially inner end portion of the holding member 62. The radially outer side of the conductive member 61 expands radially inward from the radially inner end portion of the holding member 62. A radially outer end portion of the holding member 62 is fitted to the inner peripheral surface of the shaft tubular portion 11. Alternatively, the present invention is not limited to the example of FIG. 4A, and the radially outer end portion of the conductive member 61 may be fitted to the inner peripheral surface of the shaft tubular portion 11. At this time, the radially inner side of the conductive member 61 may be held by the radially outer end portion of the holding member 62, and the radially outer side of the conductive member 61 may expand radially outward from the radially outer end portion of the holding member 62.

In the present preferred embodiment, the conductive member 61 contacts the radially outer surface of the columnar portion 442, and the holding member 62 is fixed to the inner peripheral surface of the shaft tubular portion 11. However, the present invention is not limited to the example of the present preferred embodiment, and the conductive member 61 may contact the inner peripheral surface of the shaft tubular portion 11, and the holding member 62 may contact the radially outer surface of the columnar portion 442. In the latter case, preferably, the conductive member 61 is provided in a form having rigidity like a molded body.

That is, it is sufficient for the conductive member 61 to contact one of the shaft 1 and the columnar portion 442. Further, the holding member 62 may be fixed to the other of the shaft 1 and the columnar portion 442. Then, the neutralizing device is not necessarily arranged between the shaft wall 13 and the columnar portion 442 in the axial direction, and thus, an increase in axial size of the drive device 100 can be suppressed.

In addition, the present invention is not limited to the example of FIG. 4A, and the neutralizing device 6 does not necessarily have the annular shape. For example, the neutralizing device 6 may have a rectangular parallelepiped shape as illustrated in FIG. 4B, or may have an arc shape centered on the rotation axis J1 and extending in the circumferential direction. For example, in a partial region in the circumferential direction, the conductive member 61 contacts the radially outer surface of the columnar portion 442, and the holding member 62 is fixed to the shaft 1. Conversely, in a partial region in the circumferential direction, the conductive member 61 may contact the shaft 1, and the holding member 62 may be fixed to the radially outer surface of the columnar portion 442. Since the conductive member 61 contacts the shaft 1 or the columnar portion 442 in a partial region in the circumferential direction, the sliding area of the conductive member 61 per rotation of the shaft 1 can be further reduced. Therefore, it is possible to reduce wear debris generated at the contact portion between the conductive member 61 and the shaft 1 or the columnar portion 442.

The neutralizing device 6 may further include an elastic member 63 (see FIG. 4B). The elastic member 63 is accommodated inside the holding member 62 in a compressed state. Due to the elasticity, the elastic member 63 pushes the conductive member 61 toward the shaft 1 or the columnar portion 442. As the elastic member 63, a spring coil, a leaf spring, rubber, or the like can be adopted. Although the elastic member 63 is not illustrated in FIG. 4A, the neutralizing device 6 of FIG. 4A may have the elastic member 63 as in FIG. 4B. However, these examples do not exclude a configuration in which the neutralizing device 6 does not include the elastic member 63.

The rotation detector 7 is attached to the other axial side D2 of the housing lid 43. The rotation detector 7 is arranged on the other axial side D2 with respect to the third motor bearing holder 431, and detects a rotation angle of the shaft 1. In the present preferred embodiment, the rotation detector 7 is a resolver including a resolver rotor and a resolver stator. The rotation detector 7 includes the resolver rotor (not illustrated) fixed to the shaft 1 and the resolver stator (not illustrated) fixed to the housing lid 43 of the housing 4. The resolver rotor and the resolver stator have an annular shape. An inner peripheral surface of the resolver stator radially faces an outer peripheral surface of the resolver rotor. The resolver stator periodically detects a rotation angle position of the resolver rotor when the rotor 21 rotates. As a result, the rotation detector 7 acquires information on the rotation angle position of the rotor 21. Note that the present invention is not limited to the example of the present preferred embodiment, and the rotation detector 7 is not necessarily the resolver, and may be, for example, a rotary encoder or the like.

The first seal member 81 is arranged to the other axial side D2 with respect to the neutralizing device 6 in the shaft tubular portion 11. As described above, the drive device 100 further includes the first seal member 81. The first seal member 81 has an annular shape surrounding the rotation axis J1. In the present preferred embodiment, the first seal member 81 is fixed to the radially outer surface of the columnar portion 442 and expands radially outward (see FIG. 2). However, the present invention is not limited to this example, and the first seal member 81 may be fixed to the inner peripheral surface of the shaft tubular portion 11 and may expand radially inward. That is, it is sufficient for the first seal member 81 to be fixed to one of the inner peripheral surface of the shaft tubular portion 11 and the radially outer surface of the columnar portion 442, and to expand from the one to the other in the radial direction.

Then, a gap between the inner peripheral surface of the shaft tubular portion 11 and the radially outer surface of the columnar portion 442 can be covered by the first seal member 81 expanding in the radial direction at a position on the other axial side D2 of the neutralizing device 6 in the shaft tubular portion 11. Here, for example, mist of the fluid F for lubricating and cooling the respective portions of the drive device 100 may enter the shaft tubular portion 11 at the other axial end portion of the shaft 1. Even if the fluid F enters, the fluid F can be suppressed or prevented from entering from the other axial side D2 to the one axial side D1 of the first seal member 81. Therefore, it is possible to effectively suppress or prevent the fluid F from being applied to the neutralizing device 6.

In the present preferred embodiment, the first seal member 81 is a slinger having a fixed portion (whose reference sign is omitted) and a flange portion (whose reference sign is omitted). The fixed portion of the slinger has a tubular shape extending in the axial direction. The flange portion has a plate shape expanding in the radial direction from the fixed portion, and covers the gap between the shaft tubular portion 11 and the columnar portion 442 in the radial direction. However, the first seal member 81 is not limited to this example. As the first seal member 81, an oil seal, a mechanical seal, a packing, or the like may be used.

The second seal member 82 is arranged between the third motor bearing 4311 and the rotation detector 7 in the axial direction. As described above, the drive device 100 further includes the second seal member 82. The second seal member 82 divides the third motor bearing holder 431 from the space 403 in which the rotation detector 7 is arranged. Specifically, the second seal member 82 has an annular shape surrounding the rotation axis J1 and covers a gap between the shaft 1 and the housing lid 43 (in other words, an inner peripheral surface of the opening 4312). Then, the second seal member 82 can suppress or prevent the fluid F for lubricating the third motor bearing 4311 from being applied to the rotation detector 7. Further, it is possible to suppress or prevent the fluid F from entering the space 403 in which the other axial end portion of the shaft tubular portion 11 is accommodated from the other axial end portion of the shaft 1. Therefore, it is also possible to suppress or prevent the fluid F from being applied to the neutralizing device 6 in the shaft tubular portion 11.

In the present preferred embodiment, the second seal member 82 is arranged outside the other axial end portion of the opening 4312. However, the arrangement of the second seal member 82 is not limited to the example of the present preferred embodiment. For example, the second seal member 82 may be arranged inside the opening 4312. Preferably, the second seal member 82 is arranged on the other axial side D2 with respect to the radially outer end portion of the second shaft through-hole 102. Then, it is possible to suppress or prevent the fluid F flowing out from the second shaft through-hole 102 from being applied to the rotation detector 7. However, this example does not exclude a configuration in which the second seal member 82 is arranged on the one axial side D1 with respect to the radially outer end portion of the second shaft through-hole 102.

In the present preferred embodiment, the second seal member 82 is a slinger having a fixed portion (whose reference sign is omitted) and a flange portion (whose reference sign is omitted). The fixed portion of the slinger has a tubular shape extending in the axial direction. The flange portion has a plate shape expanding in the radial direction from the fixed portion, and covers a gap between the shaft tubular portion 11 and the housing lid 43 (the inner peripheral surface of the opening 4312) in the radial direction. However, the second seal member 82 is not limited to this example. As the second seal member 82, an oil seal, a mechanical seal, a packing, or the like may be used. Alternatively, the second seal member 82 may be a part of the third motor bearing 4311. That is, the third motor bearing 4311 may be a seal-type ball bearing including the second seal member 82.

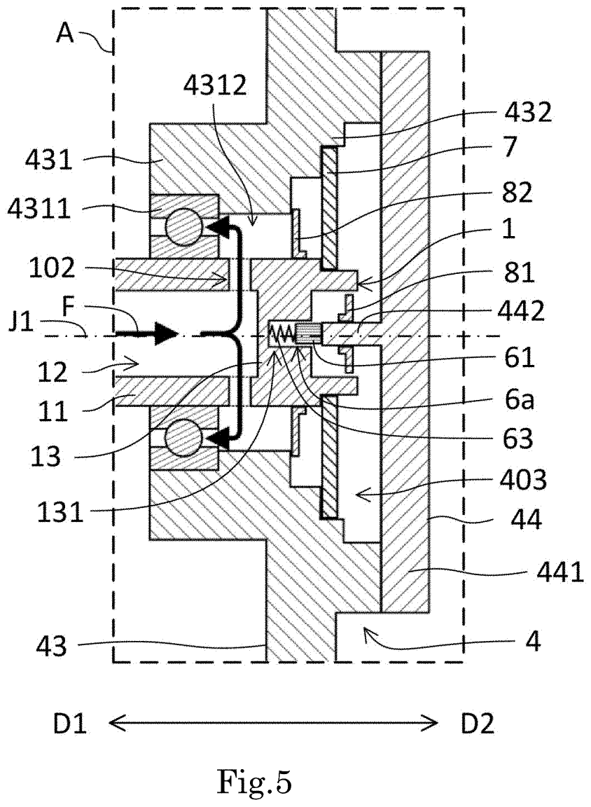

Next, a first modification of the preferred embodiment will be described with reference to FIG. 5. FIG. 5 is a conceptual diagram illustrating a shaft neutralizing structure according to the first modification. Note that FIG. 5 is a merely conceptual diagram, and a layout and a dimension of each portion are not necessarily identical to those of the actual drive device 100 in a strict sense. FIG. 5 corresponds to the portion A surrounded by the broken line in FIG. 1. Hereinafter, a configuration different from that of the above preferred embodiment will be described. In addition, the same components as those in the above-described preferred embodiment are denoted by the same reference signs, and the description thereof may be omitted.

In the first modification, a neutralizing device 6a contacts the columnar portion 442 in the axial direction. For example, as illustrated in FIG. 5, the neutralizing device 6a is fixed to the shaft wall 13 and contacts one axial end portion of the columnar portion 442. However, the present invention is not limited to the example of FIG. 5, and the neutralizing device 6a may be fixed to the one axial end portion of the columnar portion 442, and may contact the shaft wall 13. That is, it is sufficient for the neutralizing device 6a to be fixed to one of the shaft wall 13 and the one axial end portion of the columnar portion 442, and to contact the other of the shaft wall 13 and the one axial end portion of the columnar portion 442. Then, the sliding area of the neutralizing device 6a (in particular, the conductive member 61) can be significantly reduced as compared with a configuration in which the neutralizing device 6a (in particular, the conductive member 61 thereof) contacts one of the inner peripheral surface of the shaft tubular portion 11 and the radially outer surface of the columnar portion 442 (see FIG. 2). Therefore, it is possible to suppress the generation of wear debris from the neutralizing device 6a (in particular, the conductive member 61), for example.

For example, the neutralizing device 6a of the first modification includes the conductive member 61 and the elastic member 63 having conductivity. In FIG. 5, the conductive member 61 contacts the one axial end portion of the columnar portion 442. The elastic member 63 is arranged on the shaft wall 13 and pushes the conductive member 61 toward the other axial side D2. Alternatively, the present invention is not limited to the example of FIG. 5, and the conductive member 61 may contact the shaft wall 13. The elastic member 63 may be arranged at the one axial end portion of the columnar portion 442, and may push the conductive member 61 toward the one axial side D1. That is, it is sufficient for the conductive member 61 to contact one of the one axial end portion of the columnar portion 442 and the shaft wall 13. It is sufficient for the elastic member 63 to be arranged on the other of the one axial end portion of the columnar portion 442 and the shaft wall 13, and to press the conductive member 61 from the other toward the one.

Then, the shaft wall 13 and the columnar portion 442 are electrically connected to each other in the axial direction through the neutralizing device 6, and thus, it is unnecessary to form the electrical connection therebetween in the radial direction. Therefore, a radial size of the neutralizing device 6a can be further reduced, and thus, the neutralizing device 6a can be arranged compactly.

Since the elastic member 63 having conductivity pushes the conductive member 61, the conductive member 61 can continue to contact one of the one axial end portion of the columnar portion 442 and the shaft wall 13, for example, even if the conductive member 61 wears. Therefore, the neutralizing mechanism between the shaft 1 and the housing 4 using the neutralizing device 6a can be stably maintained.

In addition, the elastic member 63 is arranged on the other of the shaft wall 13 and the columnar portion 442, and the conductive member 61 is arranged between the elastic member 63 and one of the shaft wall 13 and the columnar portion 442. For this reason, it is unnecessary to newly arrange the holding member 62 (for example, see FIG. 4B) that holds the conductive member 61. Therefore, the number of components of the neutralizing device 6a can be reduced.

Preferably, the shaft wall 13 has a first recess 131 as illustrated in FIG. 5. The first recess 131 is recessed to the one axial side D1 on the other axial end surface of the shaft wall 13. At least a portion of the neutralizing device 6a on the one axial side D1 is accommodated in the first recess 131. For example, in FIG. 5, the entire elastic member 63 and a portion of the conductive member 61 on the one axial side D1 are accommodated in the first recess 131. However, the present invention is not limited to this example, and only the elastic member 63 or only a portion on the one axial side D1 thereof may be accommodated in the first recess 131. Alternatively, the entire elastic member 63 and the entire conductive member 61 may be accommodated in the first recess 131. When the elastic member 63 is arranged in the columnar portion 442 and the conductive member 61 contacts the shaft wall 13, only the conductive member 61 or at least the portion on the one axial side D1 thereof may be accommodated in the first recess 131. Alternatively, the entire conductive member 61 and at least the portion of the elastic member 63 on the one axial side D1 may be accommodated in the first recess 131. Further, the one axial end portion of the columnar portion 442 may be accommodated in the first recess 131. Then, the first recess 131 can be used as a member that holds the conductive member 61 and/or the elastic member 63. For this reason, even if vibration or the like in the radial direction occurs in the shaft 1 when the shaft 1 rotates, the neutralizing device 6a can stably maintain the electrical connection between the shaft wall 13 and the columnar portion 442. Note that the example of FIG. 5 does not exclude a configuration in which the first recess 131 is not arranged in the shaft wall 13.

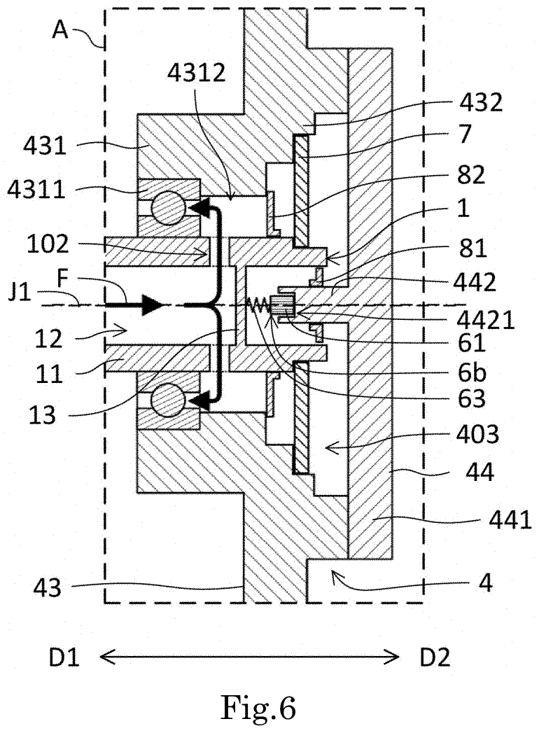

Next, a second modification of the preferred embodiment will be described with reference to FIG. 6. FIG. 6 is a conceptual diagram illustrating a shaft neutralizing structure according to the second modification. Note that FIG. 6 is a merely conceptual diagram, and a layout and a dimension of each portion are not necessarily identical to those of the actual drive device 100 in a strict sense. FIG. 6 corresponds to the portion A surrounded by the broken line in FIG. 1.

In the second modification, a second recess 4421 is arranged at the one axial end portion of the columnar portion 442. The other configurations are the same as those of the first modification. Hereinafter, a configuration different from the above first modification will be described. In addition, the same components as those in the above-described preferred embodiment and first modification are denoted by the same reference signs, and the description thereof may be omitted.

In the second modification, the columnar portion 442 has the second recess 4421 as illustrated in FIG. 6. The second recess 4421 is recessed to the other axial side D2 at the one axial end portion of the columnar portion 442. At least a portion of a neutralizing device 6b on the other axial side D2 is accommodated in the second recess 4421. For example, in FIG. 6, only a portion of the conductive member 61 on the other axial side D2 is accommodated in the second recess 4421. However, the present invention is not limited to this example, and the entire conductive member 61 may be accommodated in the second recess 4421. Further, the elastic member 63 or a portion on the other axial side D2 thereof may be accommodated in the second recess 4421. In the second modification, the elastic member 63 may be arranged in the columnar portion 442, and the conductive member 61 may contact the shaft wall 13. In this case, only at least the portion of the elastic member 63 on the other axial side D2 may be accommodated in the second recess 4421. Alternatively, the entire elastic member 63 and at least the portion of the conductive member 61 on the other axial side D2 may be accommodated in the second recess 4421. Then, the second recess 4421 can be used as a member that holds the conductive member 61 and/or the elastic member 63. For this reason, even if the shaft 1 rotates and vibrates in the radial direction, the neutralizing device 6b can stably maintain the electrical connection between the shaft wall 13 and the columnar portion 442.

In FIG. 6, the second recess 4421 is arranged instead of the first recess 131 of the first modification. However, the present invention is not limited to the example of FIG. 6, and both the first recess 131 and the second recess 4421 may be arranged in the second modification.

The preferred embodiment of the present invention has been described above. Note that the scope of the present invention is not limited to the above-described preferred embodiment. The present invention can be implemented by making various modifications to the above-described preferred embodiment within a range not departing from the gist of the invention. In addition, the matters described in the above-described preferred embodiment can be arbitrarily combined together as appropriate within a range where no inconsistency occurs.

The present invention is useful for a device that grounds a rotatable shaft. In addition, the present invention is useful for a drive device mounted on a vehicle, and is also useful for drive devices used for applications other than in-vehicle applications.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive device comprising:
a shaft extending in an axial direction along a rotation axis;
a rotor fixed to the shaft and rotatable about the rotation axis;
a stator facing the rotor in a radial direction with a gap between the stator and the rotor;
a housing accommodating the rotor and the stator; and
a neutralizing device electrically connecting the shaft and the housing,
wherein the shaft includes:
a shaft tubular portion that has a tubular shape surrounding the rotation axis; and
a shaft wall that is arranged inside the shaft tubular portion and expands in the radial direction,
a radially outer end portion of the shaft wall is connected to an inner surface of the shaft tubular portion,
the housing has a columnar portion extending to one axial side,
portions of the neutralizing device and the columnar portion on the one axial side are arranged on another axial side of the shaft wall in the shaft tubular portion, and
the neutralizing device contacts the columnar portion and at least one of an inner peripheral surface of the of the opening or on the one axial side of another axial end portion of the opening.

2. The drive device according to claim 1, wherein
the neutralizing device has an annular shape surrounding the rotation axis and is fitted to the inner peripheral surface of the shaft tubular portion.

3. The drive device according to claim 1, wherein
the neutralizing device includes a conductive member and a holding member that has conductivity and holds the conductive member,
the conductive member contacts one of the shaft and the columnar portion, and
the holding member is fixed to another of the shaft and the columnar portion.

4. The drive device according to claim 1, wherein
the neutralizing device
is fixed to one of the shaft wall and one axial end portion of the columnar portion, and
contacts another of the shaft wall and the one axial end portion of the columnar portion.

5. The drive device according to claim 4, wherein
the neutralizing device includes a conductive member and an elastic member having conductivity,
the conductive member contacts one of the one axial end portion of the columnar portion and the shaft wall, and
the elastic member is arranged at another of the one axial end portion of the columnar portion and the shaft wall, and pushes the conductive member from the other toward the one.

6. The drive device according to claim 5, wherein
the shaft wall includes a first recess recessed to the one axial side on another axial end surface of the shaft wall, and
at least the portion of the neutralizing device on the one axial side is accommodated in the first recess.

7. The drive device according to claim 5, wherein
the columnar portion includes a second recess recessed to another axial side at the one axial end portion of the columnar portion, and
at least a portion of the neutralizing device on another axial side is accommodated in the second recess.

8. The drive device according to claim 1, wherein
the shaft further includes a first seal member arranged on another axial side of the neutralizing device in the shaft tubular portion, and
the first seal member is fixed to one of the inner peripheral surface of the shaft tubular portion and a radially outer surface of the columnar portion, and expands from the one toward another in the radial direction.

9. The drive device according to claim 1, further comprising:
a bearing rotatably supporting the shaft; and
a bearing holder holding the bearing,
wherein the shaft further includes a shaft through-hole penetrating the shaft tubular portion in the radial direction or in a direction obliquely intersecting the radial direction and the axial direction,
a radially outer end portion of the shaft through-hole is connected to the bearing holder, and
a radially inner end portion of the shaft through-hole is arranged on the one axial side of the shaft wall.

10. The drive device according to claim 9, wherein
the bearing holder has an opening through which the shaft is inserted, and
one axial end portion of the shaft wall is arranged at an axial position identical to another axial end portion

11. The drive device according to claim 10, wherein
the radially outer end portion of the shaft through-hole is arranged on the one axial side of the other axial end portion of the opening.

12. The drive device according to claim 1, further comprising:
a rotation detector that is arranged on another axial side of the bearing holder and detects a rotation angle of the shaft; and
a second seal member that is arranged between the bearing and the rotation detector in the axial direction and divides the bearing holder from a space in which the rotation detector is arranged.

13. A vehicle comprising the drive device according to claim 1. shaft tubular portion and another axial end surface of the shaft wall.
